(19) United States
(12) Patent Application Publication
(10) Pub. No.: US 2010/0181242 A1
(43) Pub. Date: Jul. 22, 2010

(54) FILTER PANEL

(75) Inventor: Manfred P. Hermann, Nürnberg (DE)

Correspondence Address: LERNER GREENBERG STEMER LLP, P O BOX 2480, HOLLYWOOD, FL, 33022-2480, US

(73) Assignee: JVK FILTRATION SYSTEMS GMBH, Georgensgmünd (DE)

(21) Appl. No.: 12/690,640

(22) Filed: Jan. 20, 2010

Related U.S. Application Data
(63) Continuation of application No. PCT/EP2008/005567, filed on Jul. 9, 2008.

(30) Foreign Application Priority Data
Jul. 20, 2007 (DE) 20 2007 010 141.4
Jan. 30, 2008 (DE) 20 2008 001 380.1

(51) Int. Cl. B01D 25/164

(52) U.S. Cl. 210/228

(57) ABSTRACT

A filter panel contains a sludge inlet, a distributor ring which is arranged at the sludge inlet and has at least one inlet channel, and a support ring assigned to the distributor ring. A protective lip is mounted on the support ring and rests on the distributor ring in its closed position and partly covers the inlet channel.

### CROSS-REFERENCE TO RELATED APPLICATION

This is a continuation application, under 35 U.S.C. §120, of copending international application No. PCT/EP2008/005567, filed Jul. 9, 2008, designated the United States; this application also claims the priority, under 35 U.S.C. §119, of German patent application Nos. DE 20 2007 010 141.4, filed Jul. 20, 2007, and DE 20 2008 001 380.1, filed Jan. 30, 2008; the prior applications are herewith incorporated by reference in their entirety.

### BACKGROUND OF THE INVENTION

### Field of the Invention

The invention relates to a filter panel for a filter press. Filter presses of this type contain a filter panel pack composed of a plurality of filter panels. The filter panel pack itself is composed of a plurality of filter panels arranged adjacent to one another in pairs, which filter panels bear partially against one another and between them form a filter chamber. For this purpose, the filter panels have a central filter surface and a sealing edge which borders the central filter surface and which is thickened in cross section. The filter panels bear with their sealing edges, which are thickened in relation to the filter surface, against one another such that an intermediate space is left free between the filter surfaces of mutually adjacent filter panels. The intermediate chamber between two adjacent filter panels is utilized as a filter chamber. The filter panels may be moved away from one another and toward one another in the filter press. The mobility serves to open and close the filter chambers.

For filling the suspension to be filtered, which is conventionally referred to as pulp, a pulp inlet is provided at least on every second filter panel or else on every filter panel. The pulp inlet may be arranged either in the region of the filter surface of the filter panel or in the region of the sealing edge or else outside the sealing edge. To reliably conduct the pulp into the filter chamber, the pulp inlet is provided with filling aids which may be embodied as filling spouts, filling slots or filling ducts. The present invention encompasses all common types of filling aids. These are referred to below as inlet duct. Such inlet ducts are expediently coupled to so-called distributor rings. The distributor rings are themselves adapted to the pulp inlet, such that the pulp passes into the inlet ducts via the distributor ring and the pulp itself is conducted via the inlet ducts into the filter chamber.

To form as large a filter chamber as possible, which filter chamber is suitable for filtering as large a volume as possible, the largest possible filter surfaces are used. Since the filter surfaces are subjected to very high pressures during the filtering process, there is the tendency for the filter surfaces of the individual filter panels to deform. To limit or control the deformation, it is known to provide one or more support rings on the filter surface. In particular in the region of the pulp inlets or the filter chamber inlet, the deformation behaviors of the mutually adjacent filter panels are coordinated with one another by virtue of the support ring of one filter panel being supported on the distributor ring of the adjacent filter panel when the filter chamber is closed.

It is also known, in order to form so-called membrane filter presses, to configure two adjacent filter panels as a panel pair such that one filter panel is additionally provided with a membrane in order to form a membrane filter panel, while the second panel, without a membrane, forms a chamber filter panel. This is known for example from German utility model DE 203 17 546 U.

After a certain period of operation or filtration, a filter cake has formed in the filter chamber, which filter cake must be removed from the filter chamber. This takes place by opening the closing device of the filter press and pushing the individual filter panels apart. The filter cake is removed, and is either processed further or disposed of.

In membrane press filters, the elastic membranes of the membrane panels are acted on with compressed air before the closing device is opened. In this way, the membranes, with the filter cloth stretched over them, are pressed against the filter cake. As a result of the pressing process, moisture is substantially extracted from the filter cake. The filter cake can thereby first be easily cleared out. Furthermore, the filter cake can be easily processed further.

During the pressing process, in particular in the case of a filter cake which contains a particularly large quantity of liquid and which is therefore soft or in the case of a filter cake which is not fully formed, it can be the case that the filter cake imparts only a low resistance to the membrane during the pressing process. As a result, the membrane presses the filter cloth in the region of the inlet ducts of the distributor ring into the inlet ducts. As a result, the membrane and the filter cloth can tear. The tearing of the filter cloth and/or of the membrane leads to an impairment of the filtration performance and, in the worst case, to a relatively long failure of the filter, since repair measures must be undertaken.

### SUMMARY OF THE INVENTION

It is accordingly an object of the invention to provide a filter panel which overcomes the above-mentioned disadvantages of the prior art methods and devices of this general type, which prevents tearing of the filter cloth or of the membrane.

With the foregoing and other objects in view there is provided, in accordance with the invention a filter panel pack. The filter panel pack contains at least one chamber filter panel, including a pulp inlet being substantially circular in cross section; and a distributor ring disposed on the pulp inlet and has at least one inlet duct for pulp. A membrane filter panel is situated opposite the chamber filter panel. The membrane filter panel contains a pulp inlet being substantially circular in cross section; a support ring disposed on the pulp inlet of the membrane filter panel and situated opposite the distributor ring of the chamber filter panel; a filter surface; a membrane mat disposed on the filter surface; and a filter cloth stretched over the membrane mat. The chamber filter panel and the membrane filter panel enclose a filter chamber. The membrane mat is disposed on that side of the filter surface facing toward the chamber filter panel and with the filter cloth disposed on that side of the membrane mat facing toward the chamber filter panel. At least one protective lip is pivotably mounted on the support ring and is spatially disposed substantially between the filter cloth and the distributor ring and which, when in its closed position, bears against the distributor ring and at least partially covers the inlet duct.

For this purpose, a protective lip is pivotably mounted on the support ring, which protective lip, in its closed position, bears against the distributor ring and entirely or, in the manner of a valve, partially covers the inlet ducts. The protective lip is thus arranged between first the filter cloth and/or the membrane and second the inlet ducts. During the pressing process, therefore, the membrane with the filter cloth is pressed no longer against the inlet ducts but rather against the protective lip. The protective lip can hereby be configured so as to form a planar surface which is substantially matched to the contour of the distributor ring, such that an inadvertent tearing of the filter cloth is reliably prevented. Complex repair measures which lead to an operating situation of the filter press no longer occur.

Since a filter press of this type is conventionally operated with an overpressure of 5 bar and higher, the protective lip is reliably pivoted to the side, and opens up the inflow ducts into the filter chamber, when acted on with the liquid to be filtered. The distributor ring may therefore remain substantially unchanged with regard to the arrangement of the inflow ducts, such that nothing need be changed in the design of the filter press with regard to the flow and pressure conditions.

A protective lip of this type may for example be realized by virtue of that flange section of the support ring which is situated opposite the flange section of the distributor ring with the inlet ducts being provided, at its end, with an in particular tab-like protective lip. The protective lip is connected to the flange of the support ring. This is achieved for example by a thinned material portion, such that the support ring can be produced with the protective lip as an integral component. Suitable materials for the support ring are for example metal or plastic, such as an elastomer, such that the protective lip, which is connected to the flange of the support ring in a hinged fashion, has a sufficient degree of elasticity.

In another variant, the hinge is formed in the manner of a film hinge as a separate component which connects the support ring and the protective lip. For this purpose, the hinge is in particular adhesively bonded, welded or screwed to the support ring and to the protective lip. Here, too, the hinge may be produced from a flexible elastomer.

In both variants, therefore, it is ensured that the protective lip can be pivoted toward the inlet ducts during the pressing process. Furthermore, it is ensured that the protective lip can also perform a multiplicity of the pivoting movements without mechanical damage.

The protective lip is expediently configured so as to cover those ends of the inlet ducts which face toward the filter chamber. Since precisely those ends of the inlet ducts project furthest into the filter chamber, the risk of the formation of a tear in the filter cloth is particularly high there. If the inlet ducts are completely covered, then damage to the filter cloth by the inlet ducts is prevented.

In one expedient refinement, a bevel as a contact surface for the protective lip is provided on the distributor ring. Here, the bevel may be configured such that, during the pressing process, the protective lip bears substantially in a positively locking fashion against the end of the distributor ring and hereby completely covers the inlet ducts. Furthermore, the bevel ensures that the protective lip is not, for example, bent too far. The risk of mechanical damage to the hinge by being bent too far is therefore eliminated.

In a first preferred embodiment of the invention, the distributor ring and the support ring are integrally connected to one another. The distributor ring and support ring thereby form an integral component. The integral component is particularly suitable for retrofitting on existing filter panels. The integral component therefore performs a dual function. First, the pulp or the suspension is reliably introduced into the filter chamber via the inlet ducts of the distributor ring. Second, the protective lip reliably covers the inlet ducts during the pressing process. By the integral design, the protective lip and the inlet ducts can be coordinated with one another particularly effectively in terms of function.

In a further refinement, the inlet ducts are arranged between the support ring and distributor ring such that the inlet ducts are substantially closed. In this way, the inlet ducts can be configured particularly expediently in terms of flow.

In the case of a membrane filter press, it is advantageous for the integral component to be fixed to the pulp inlet of the chamber filter panel.

In a preferred second embodiment, the distributor ring on the one hand and the support ring on the other hand are assigned two different filter panels. These are the filter panels which ultimately between them form the panel pair with a common filter chamber.

The support ring is advantageously assigned to the membrane filter panel and the distributor ring is advantageously assigned to the chamber filter panel. In this way, it is possible for the filter chamber to be filled from the pulp duct by inlet ducts running substantially perpendicular to the pulp duct profile. A complex geometry of the inlet ducts need not be provided.

In conformance with the filtration process, the pulp inlet—as already mentioned—is arranged either in the region of the filter surface or in the sealing edge or outside the sealing edge and the filter surface. To cover all three arrangements, suitable embodiments of the invention are provided for the respective type of arrangement. This also has the advantage that the invention may be used for already existing filter panels or filter presses in which the respective arrangement of the pulp inlet can no longer be retroactively changed. The assembly of the single-piece component or of the separate support and distributor rings may take place either during the initial assembly or else during retrofitting by a screw connection, a clip closure or by a flexible grip ring.

In the case of pulp inlets arranged in the region of the filter surface, in particular in the case of pulp inlets arranged in the center of the filter surface, it is expedient for the inlet ducts to be grouped in stellate fashion around the pulp inlet. As a result of the star-shaped arrangement, a uniform distribution of the pulp in all directions is ensured. An angle of 30° between the individual inlet ducts is preferably not undershot here. In the stellate arrangement of the inlet ducts, each inlet duct is, in a simplified configuration, assigned a separate protective lip. As a result of the stellate arrangement of the inlet ducts, the individual protective lips are arranged in a polygonal fashion. This means that the virtual line which connects the protective lips to one another is a polygon.

The arrangement of the pulp inlet in the sealing edge or outside the sealing edge, as is provided in a further refinement, is dependent substantially on the thickness of the sealing edge. If the width of the sealing edge itself is large enough for the pulp inlets to be formed therein, it is expedient for the pulp inlets to be integrated in the sealing edge. In contrast, if a relatively large installation space is required for the pulp inlets, the space outside the filter panel is used for this purpose. In this embodiment, the pulp inlets then project in the manner of lugs out of the sealing edge. In both designs, it is possible in a simple refinement in terms of production to use a plurality of inlet ducts running parallel to one another. This facilitates the use of only one protective lip to cover all the inlet ducts. In another refinement, which facilitates a particularly good distribution of the pulp, the inlet ducts may be arranged at an angle relative to one another. The inlet ducts then have a diffuser-like effect as the pulp is introduced into the filter chamber. Here, the inner angle between the individual inlet ducts should expediently not exceed 30°.

The embodiment of the invention in which the support ring and protective lip are composed of the same material is expedient in production terms. Depending on the respective application of the filter panels, suitable materials are for example plastic or metal, for example high-grade steel.

It is expedient, since it is easy in production terms, for the protective lip to be mounted on the support ring by a film hinge. To improve the protective action of the protective lip, it is provided in a further refinement that the protective lip itself is formed as a flexurally rigid lip tab which is connected to the pivotable hinge part. The design, which is divided into two distinct parts, has the advantage that the hinge can still be produced simply and cheaply in production terms as a film hinge. For this purpose, the film hinge contains a carrier skirt. A flexurally rigid lip tab is adapted on the carrier skirt. The flexurally rigid lip tab is expediently adapted to the contour of the associated distributor ring, which leads to particularly good coverage of the inlet duct assigned thereto in each case. In addition to the integral design of the film hinge and protective lip from one material, the protective lip may be welded to the film hinge. It is also possible for the flexurally rigid lip tab to be welded or clipped or screwed to the carrier skirt. It is also conceivable for the protective lip to be pivotably mounted on the support ring by a clip connection.

In a further refinement of the invention, it is provided that the protective lip or the flexurally rigid lip tab is configured to be exchangeable. In this way, it is possible for a worn protective lip to be replaced separately without having to exchange the associated support ring.

Other features which are considered as characteristic for the invention are set forth in the appended claims.

Although the invention is illustrated and described herein as embodied in a filter panel, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an edge region of a filter panel pair with pulp inlet arranged outside a sealing edge;

FIG. 2 is a diagrammatic, perspective view of a distributor ring;

FIG. 3 is a diagrammatic, perspective view of a support ring;

FIG. 4 is a diagrammatic, sectional view of an edge region of the filter panel pair from FIG. 1 in an assembled state;

FIG. 5 is a diagrammatic, sectional view of a detail from FIG. 4;

FIG. 6 is a diagrammatic, sectional and perspective illustration of the edge region of a filter panel pair with the pulp inlet arranged outside the sealing edge and with a support ring arranged on the membrane filter panel and with a distributor ring arranged on the chamber filter panel;

FIG. 7 is a diagrammatic, sectional and perspective illustration of the edge region of a filter panel pair with the pulp inlet arranged outside the sealing edge, with a single-piece configuration of the support ring and distributor ring with an arrangement on the chamber filter panel;

FIG. 8 is a diagrammatic, perspective overall illustration of the single-piece component composed of the distributor ring and support ring, as per FIG. 7;

FIG. 9 is a front view of the component illustrated in FIG. 8;

FIG. 10 is a side view of the component illustrated in FIGS. 8 and 9;

FIG. 11 is an illustration of detail XI shown in FIG. 10;

FIG. 12 is a sectional view of a two-part protective lip with a film hinge;

FIG. 13 is a perspective view of a chamber filter panel with a central pulp inlet;

FIG. 14 is a perspective view of a component combination of a support ring according to the invention and distributor ring for a filter panel pair with central pulp inlet, as per FIG. 13, with the protective lip open,

FIG. 15 is a side view of the support ring and the distributor ring shown in FIG. 14, with the protective lip open;

FIG. 16 is a sectional view taken along the section line XVI-XVI shown in FIG. 15;

FIG. 17 is a sectional view as in FIG. 16, but with the protective lip closed; and

FIG. 18 is a perspective, sectional view of the distributor ring and the support ring illustrated in FIG. 17, with the protective lip closed.

### DETAILED DESCRIPTION OF THE INVENTION

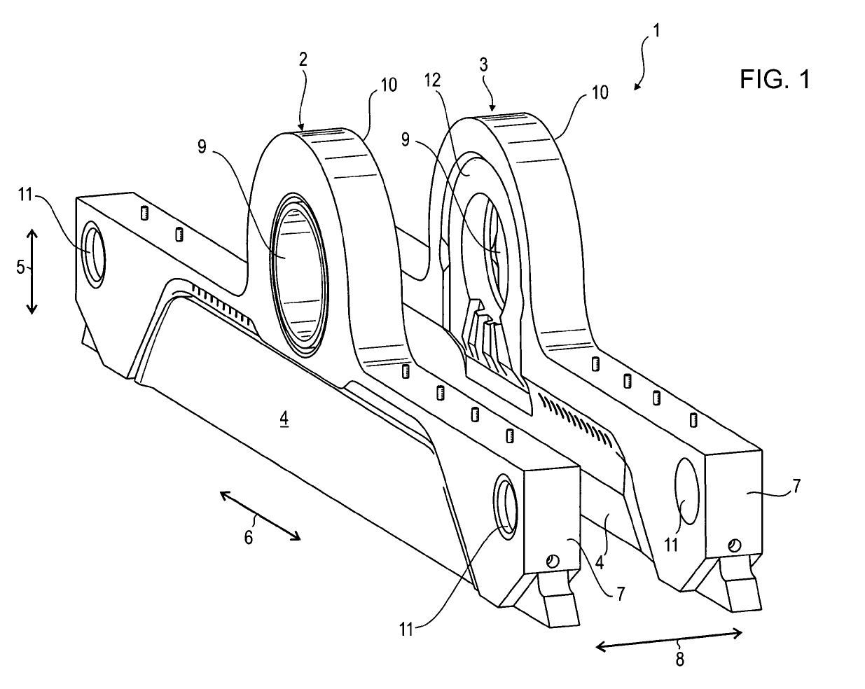

Referring now to the figures of the drawing in detail and first, particularly, to FIG. 1 thereof, there is shown a filter panel pack 1 which contains a membrane filter panel 2 and a chamber filter panel 3 as part of a non-illustrated membrane press filter. Each filter panel 2, 3 has an inner panel body with a panel surface, the filter surface 4, on both sides. The filter surface 4 is surrounded at the edge both in the vertical direction 5 and also in the transverse direction 6 by a panel edge, a sealing edge 7, which is thickened in relation to the filter surface 4. In other words, the sealing edge 7 runs around the filter surface 4 in the vertical direction 5 and in the transverse direction 6. FIG. 1 illustrates only the upper part of the two filter panels 2, 3. The sealing edge 7 and the filter surface 4 should be imagined as continuing downward in the vertical direction 5.

The sealing edge 7 projects a considerable distance beyond the filter surface 4 in a panel assembly direction 8 on both sides. Centrally in the transverse direction 6, the sealing edge 7 is adjoined in the vertical direction 5 by a pulp inlet 9, an enclosure 10 of which has the same thickness as the sealing edge 7. The enclosure 10 is therefore an elongation of the sealing edge 7 in the vertical direction 5. FIG. 1 therefore shows an embodiment of the filter panel 2, 3 with the pulp inlet 9 which projects out of the sealing edge 7 in the manner of a lug and which is situated outside the sealing edge 7 and outside the filter surface 4. In the transverse direction 6, each filter panel 2, 3 has a filtrate bore 11 at their two ends.

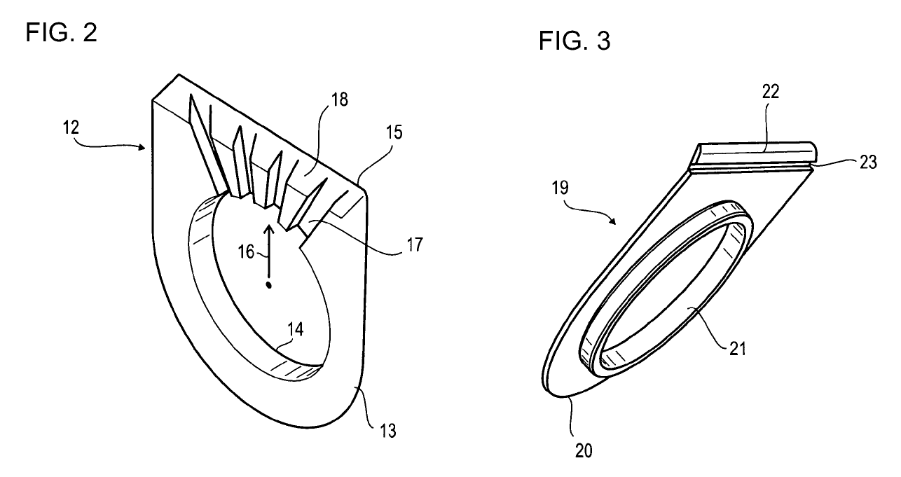

A distributor ring 12, which is illustrated separately in FIG. 2, is inserted into the chamber filter panel 3. According to FIG. 2, the distributor ring 12 has a flange 13 and a pipe section 14. A flange collar 15 is arranged on the flange 13, with a total of four inlet ducts 17 which run obliquely relative to one another at an angle of less than 30° extending through the flange collar 15 in the radial direction 16 in the exemplary embodiment. The flange collar 15 has a bevel 18 at its end directed outward in the radial direction 16.

FIG. 3 shows a support ring 19 which contains a flange 20 and a pipe section 21. A tab-like protective lip 22 is pivotably mounted on the flange 20 of the support ring 19 by a hinge 23 formed as a thinned material portion in the manner of a film hinge. The support ring 19 is produced in one piece from an elastomer. The protective lip 22 can therefore be easily pivoted about the hinge 23.

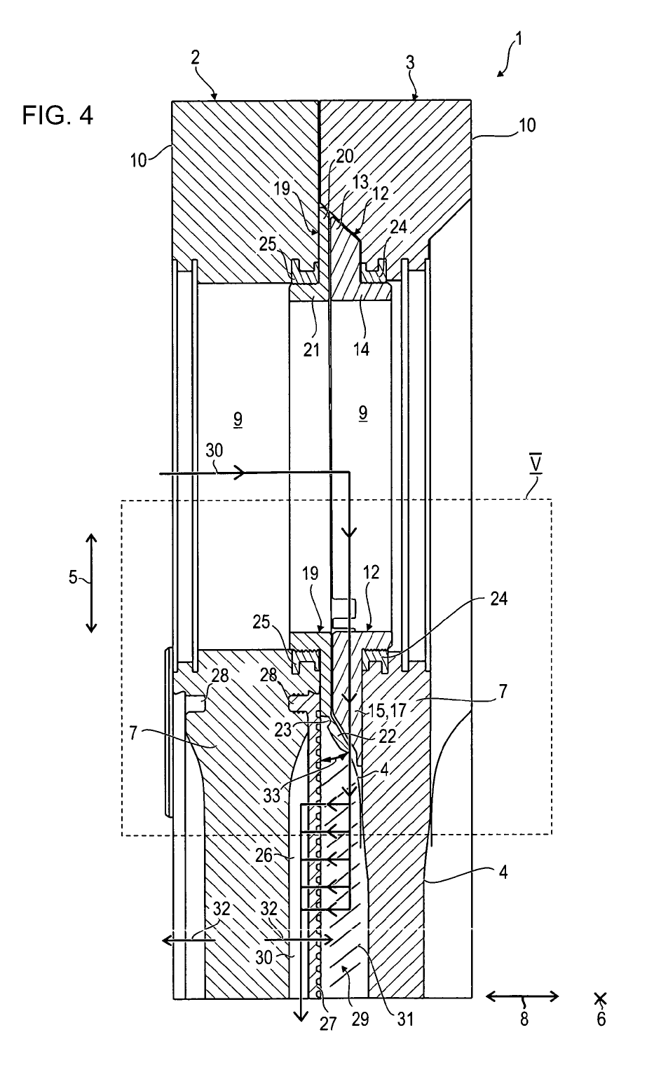

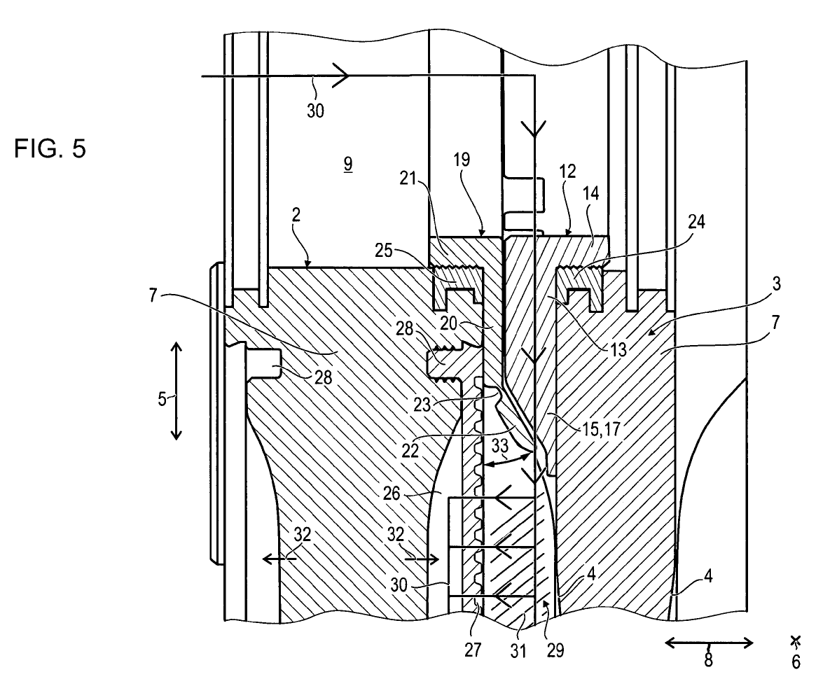

FIG. 4 shows the two filter panels 2, 3 in the assembled state. Here, the pulp inlets 9 of the filter panels 2, 3 are cut centrally in the panel assembly direction 8 in the region of the enclosures 10. For assembly, the two filter panels 2, 3 are pushed against one another in the panel assembly direction 8 until their sealing edges 7 and their enclosures 10 abut against one another. The distributor ring 12 is pushed with its pipe section 14 into the pulp inlet 9 of the chamber filter panel 3 and is fixed by a connecting element 24. Here, the flange collar 15 is aligned downward in the vertical direction 5. The support ring 19 is pushed with its pipe section 21 into the pulp inlet of the membrane filter panel 2 and is fixed by a further connecting element 25. In the assembled state, the two flanges 13, 20 of the distributor ring 12 and support ring 19 bear against one another and are supported against one another. This can be seen in particular from FIG. 5, as an enlarged detail from FIG. 4.

A membrane mat 26 is fastened at both sides to the filter surface 4 of the membrane filter panel 2 by non-illustrated knobs. A filter cloth 27 is stretched over the membrane mat 26, which filter cloth 27 is supported on the non-illustrated knobs of the membrane mat 26. The filter cloth 27 is fastened in the region of the sealing edge 7 by fastening elements 28. The membrane mat 26 and filter cloth 27 thereby form a system of collecting ducts which extends over the entire filter surface 4.

The principle for the fastening of the distributor ring 12 and of the support ring 19 by the connecting elements 24, 25 and for the fastening of the filter cloth 27 by the fastening elements 28 is described in detail in German utility model DE 203 17 546 U.

In the assembled state, the enclosures 10 of the pulp inlets 9 of the membrane filter panel 2 and the chamber filter panel 3 bear against one another. The pulp inlets 9 together form a pulp duct. Furthermore, the sealing edges 7 of the membrane filter panel 2 and chamber filter panel 3 bear against one another all the way around in the vertical direction 5 and in the transverse direction 6. A filter chamber 29 is thereby formed between the filter surface 4 of the membrane filter panel 2 with its filter cloth 27 and the filter surface 4 of the chamber filter panel 3. The flange 13 of the distributor ring 12 projects with its flange collar 15 into the filter chamber 29. In this way, a continuous connection is produced between the filter panel 29 and the pulp duct via the inlet ducts 17. Here, the inlet ducts 17 are covered, with the exception of their ends directed toward the filter chamber 29, by the flange 20 of the support ring 19 in order to form a filter chamber inlet 12, 19. The inlet ducts 17 which open out into the filter chamber 29 vertically from the pulp inlet 9 are covered by the flange collars 15 in FIGS. 4 and 5. This is indicated by the respective common reference symbol 15, 17. The protective lip 22 is arranged opposite the ends of the inlet ducts 17 and between the filter cloth 27 and the inlet ducts 17. The filtrate bores 11 shown in FIG. 1 form, in the panel assembly direction 8 in relation to the overall filter panel pack 1, a total of four filtrate ducts (not visible in the figure).

In filter operation, the filter panel pack 1 is acted on with a suspension to be filtered. Here, the suspension follows filtration path 30 through the filter panel pack 1. The suspension passes, with an overpressure of approximately 5 bar, via the pulp duct into the filter panel pack. From the pulp duct, the suspension passes through the inlet ducts 17 into the filter chamber 29. The liquid component of the suspension passes through the filter cloth 27 and is discharged via the collecting ducts of the membrane mat 26. The collecting ducts are connected to the filtrate bores 11 via filtrate ducts which are formed in the sealing edge 7 and which are not illustrated in the figures. The filtrate is discharged via the filtrate bores 11. With progressive operating duration or filtration time, a filter cake 31, illustrated by hatching in FIGS. 4 and 5, is formed in the filter chamber 29.

The filter cake 31 must be cleared out from time to time. For this purpose, the membrane filter panels 2 are acted on with compressed air. In this way, the walls of the membrane filter panel 2 expand in an expansion direction 32 at both sides in the panel assembly direction 8. The membrane mats 26 now exert a pressure with their outer sides, which are lined with the filter cloth 27, on the filter cake 31 in the expansion direction 32. Here, a significant part of the residual moisture of the filter cake 31 is extracted from the latter. In the region of the inlet ducts 17, the protective lip 22 is pressed, from its side facing away from the inlet ducts 17, by the filter cloth 27 against the bevel 18 of the flange collar 15 in the pivoting direction 33. In this way, trapping of the filter cloth 27 in the inlet ducts 17, and possible damage to the filter cloth 27 in particular by tearing, is effectively prevented.

After the filter cake 31 is pressed out, the individual filter panels 2, 3 are pulled apart in the panel assembly direction 8. The filter cakes 31 are removed and, for example, processed further or disposed of. After the filter panels 2, 3 have been pushed together again, the filter cycle begins anew.

Since the filtering is carried out at an overpressure of approximately 5 bar, the suspension which flows through the inlet ducts pushes the protective lip 22 away from the bevel 18 of the flange collar 15 and thereby at any rate opens up the inlet ducts 17. Mechanical damage to the hinge 23 by which the protective lip 22 is connected to the flange 20 does not occur. This is because the pivoting direction 33 of the protective lip 22 is limited at one side by the filter cloth 27 and at the other side by the bevel 18.

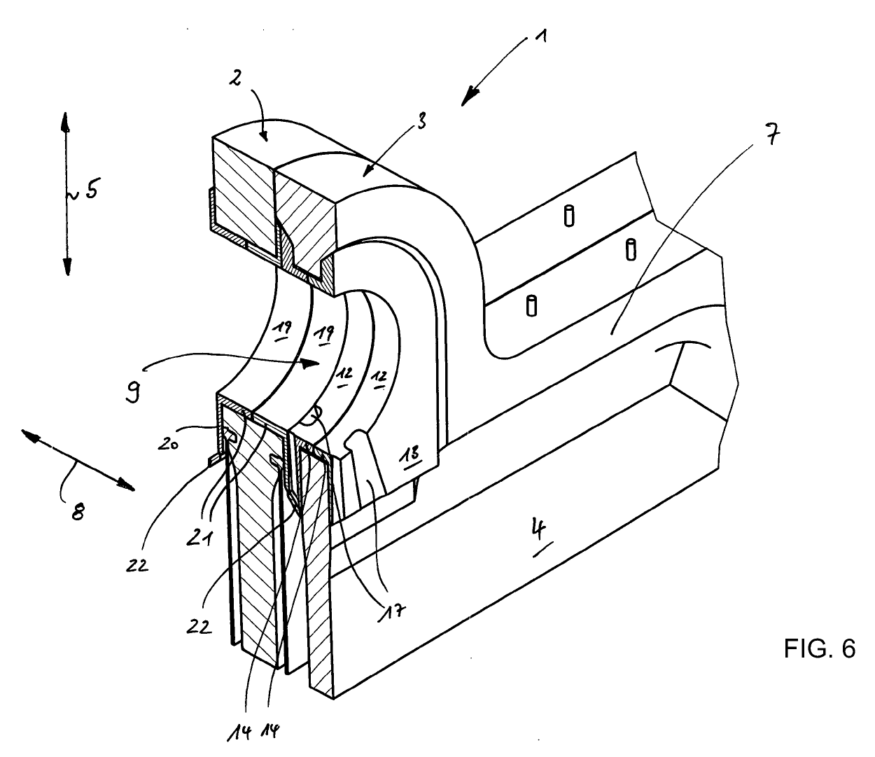

The filter panel pack 1 illustrated in FIG. 6 is composed of the membrane filter panel 2 and the chamber filter panel 3. The membrane filter panel 2 bears, in the region of its pulp inlet 9, the two support rings 19 which face away from one another in the panel assembly direction 8. The support rings 19 abut with their pipe sections 21 against one another. The flanges 20, which run substantially at right angles to the pipe sections 21, support in each case one protective lip 22 at their ends facing away from the pipe sections 21 in the vertical direction 5.

Similarly, two distributor rings 12 which face away from one another in the panel assembly direction 8 are arranged in the pulp inlet 9 of the chamber filter panel 3. The distributor rings 12 abut with their pipe sections 14 against one another in the panel assembly direction 8. In the exemplary embodiment of FIG. 6, in each case one inlet duct 17 is formed into the flanges 13, which run substantially in the vertical direction 5, of the distributor rings 12. It can be seen from the illustration of FIG. 6 that the right-hand protective lip 22 in the drawing closes off the inlet duct 17 which is enclosed between the membrane filter panel 2 and the chamber filter panel 3. For this purpose, the protective lip 22 which is mounted on the support ring 19 bears against the flange 13 of the distributor ring 12.

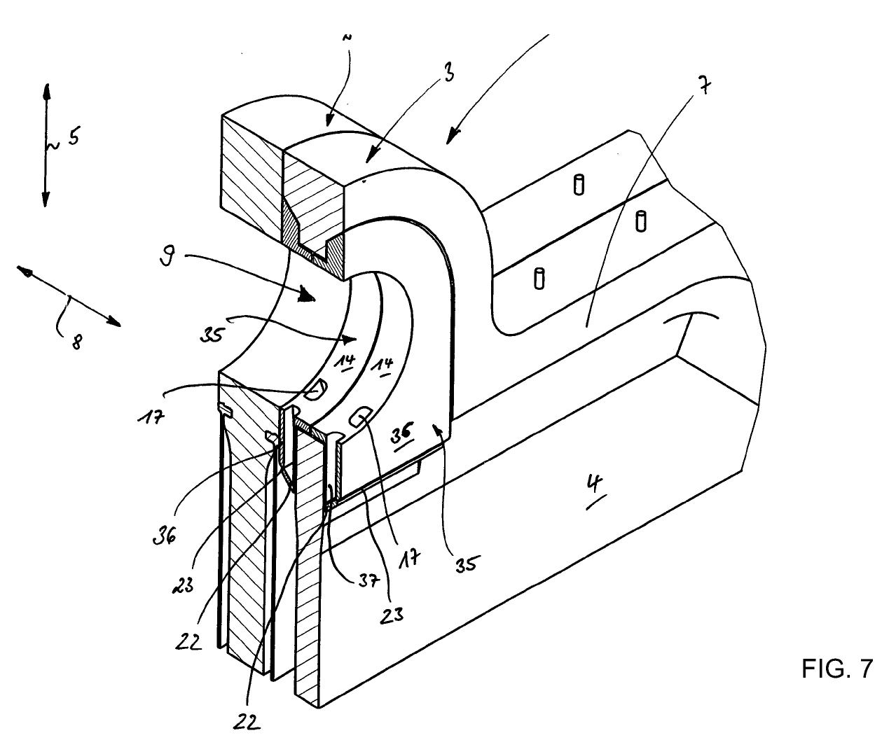

In the single-piece embodiment illustrated in FIG. 7, the distributor ring and support ring form a component 35. FIG. 7 shows two components 35 which face away from one another in the panel assembly direction 8 and which are arranged in the region of the pulp inlet 9. The components 35 each have a pipe section 14 which, in the illustration of FIG. 7, runs in the panel assembly direction 8. The pipe section 14 is delimited at the edge by a support flange 36. A distributor flange 37 runs in the panel assembly direction 8 parallel to the support flange 36. With the distributor flange 37, the component 35 bears flush against the edge of the pulp inlet 9. With the distributor flange 37, the component 35 engages partially over the sealing edge 7. In each case one inlet duct 17 is formed into the distributor flange 37 in the exemplary embodiment of FIG. 7.

The protective lip 22 is integrally formed, by a hinge 23, on the support flange 36 at that end of the latter which faces away from the pipe section 14 in the vertical direction 5. The protective lip 22 abuts with its end edge facing away from the hinge 23 against the distributor flange 37 and thereby in turn seals off the end of the inlet duct 17 from the filter chamber 29.

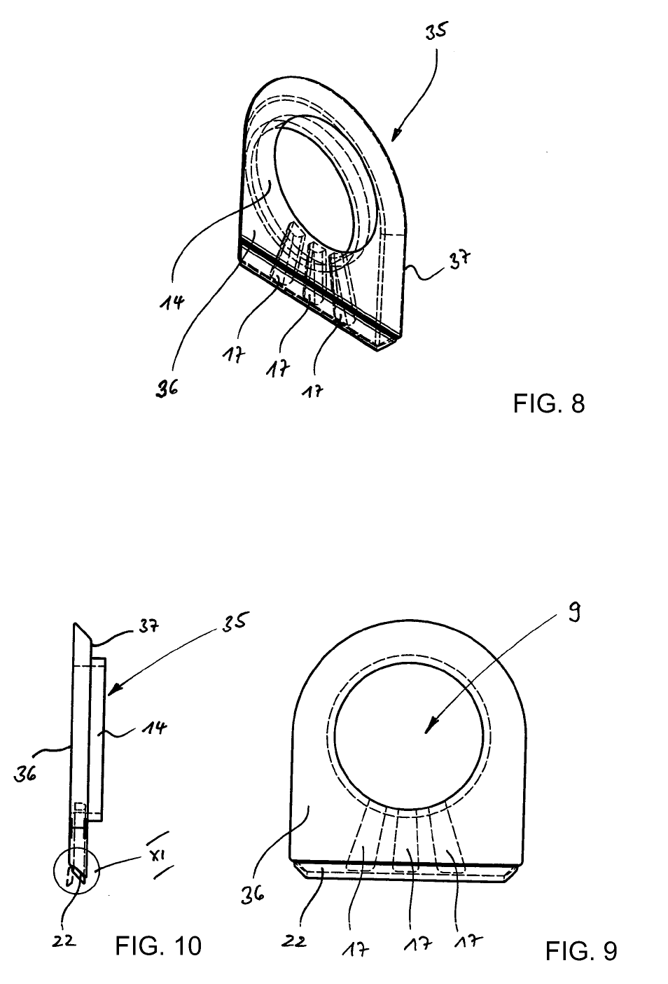

It can also be seen from the illustration of FIG. 7 that the component 35 simultaneously performs both the distributor function of a distributor ring and also the support function of a support ring. The component 35 is shown again in FIG. 8. FIG. 8 shows three inlet ducts 17 running obliquely relative to one another. It is particularly advantageous for the angle of inclination between the inlet ducts 7 not to exceed a value of 30°. In all the embodiments of the invention, the inlet ducts 17 are configured so as to open conically from the pulp inlet 9 in the direction of the filter chamber 29. The inlet ducts 17 may be either of single-part or multi-part configuration. It is likewise possible for the inlet ducts 17 to be formed with a circular cross section.

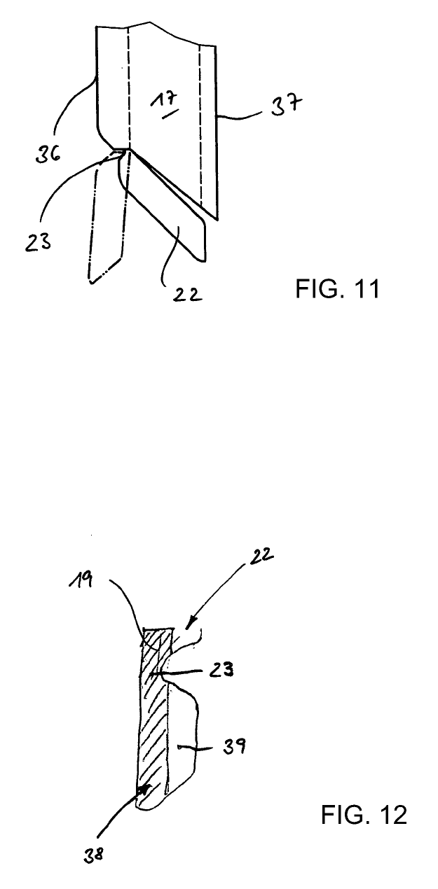

FIG. 11 clearly shows an inlet duct 17 running between the support flange 36 and the distributor flange 37. The figure also shows the protective lip 22 which is pivotably mounted on the lower end of the support flange 36 by a hinge 23. FIG. 12 shows the lower end of the support ring 19 or of the support flange 36. The lower end of the support ring 19 is adjoined by the hinge 23, which is formed as a film hinge. The hinge 23 is realized by a thinned material portion. The hinge 23 is adjoined in turn by a carrier skirt 38, which is likewise composed of rubber. Here, the carrier skirt 38, the hinge 23 and the end of the support ring 19 are formed from the same material. In the exemplary embodiment this is rubber. The flexurally rigid lip tab 39 is fixed to the carrier skirt 38. The flexurally rigid lip tab 39 is composed of suitably rigid material, for example steel or plastic. The flexurally rigid lip tab 39 may—as in the exemplary embodiment—be adhesively bonded to the carrier skirt 38. It is also possible for the carrier skirt 38 and the lip tab 39 to be of integrated design using a two-component material. It is also possible for the carrier skirt 38 and lip tab 39 to be clipped or screwed or welded to one another.

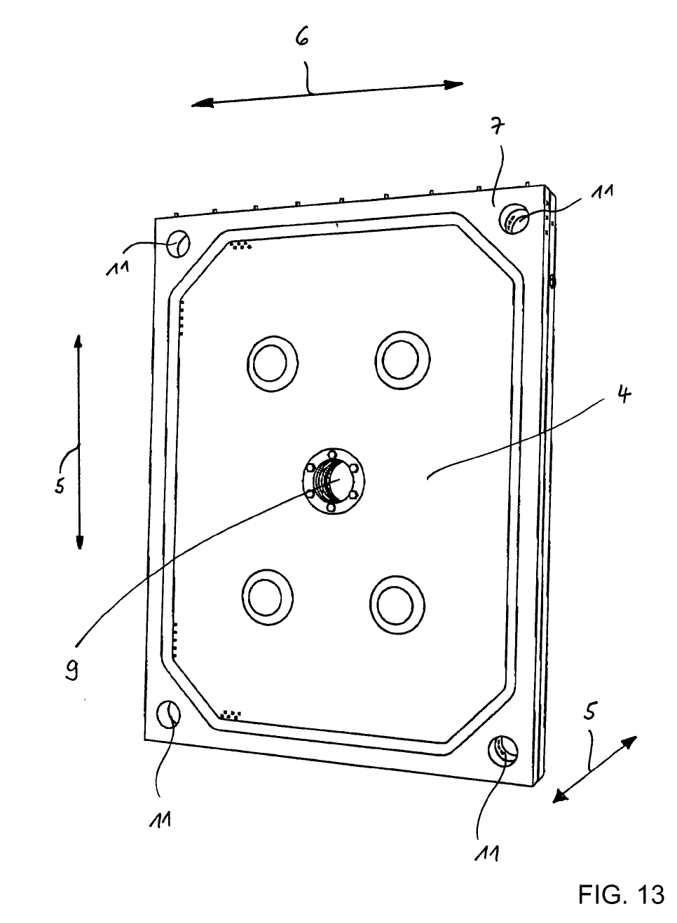

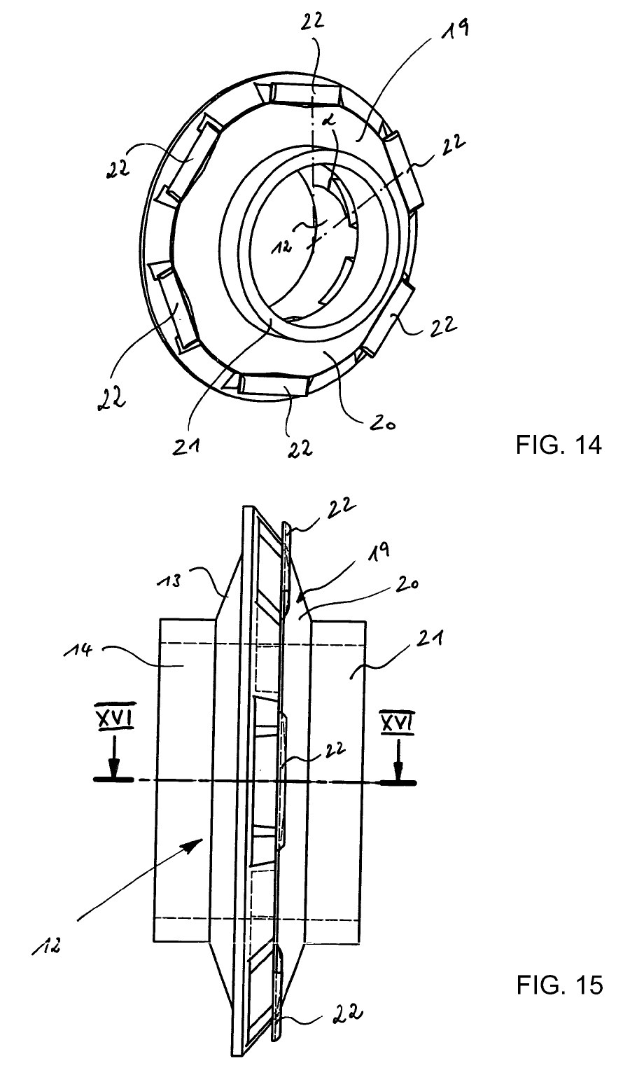

FIG. 13 shows, by way of example, a filter panel with a centrally arranged pulp inlet 9. FIG. 14 shows a ring combination composed of a support ring 19 and a distributor ring 12, which ring combination is suitable for being assembled into a panel pair with a centrally arranged pulp inlet 9, as per the exemplary embodiment shown in FIG. 13.

The perspective illustration of FIG. 14 shows, in the foreground, the support ring 19 to be inserted into the central pulp inlet 9 of a chamber filter panel 3 according to FIG. 13. Visible in the background is a distributor ring 12 which is assigned to the support ring 19. The distributor ring 12 is likewise configured to be inserted into the central pulp inlet 9 of a filter panel, which is configured as a membrane filter panel 2, according to FIG. 13. The distributor ring illustrated in FIGS. 14 to 18 has a total of six inlet ducts 17 arranged in stellate fashion. Accordingly, six protective lips 22 are formed on the support ring 19 at the six inlet ducts 17. The inner angle α between two inlet ducts 17 is 30° or greater in the embodiment with inlet ducts 17 arranged in stellate fashion.

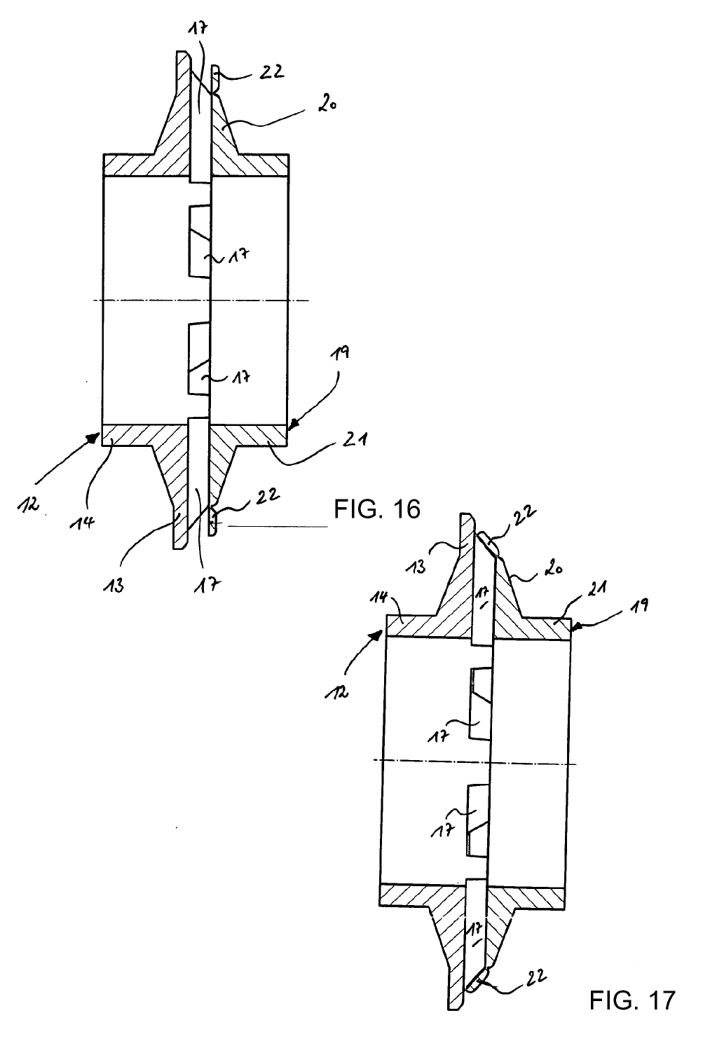

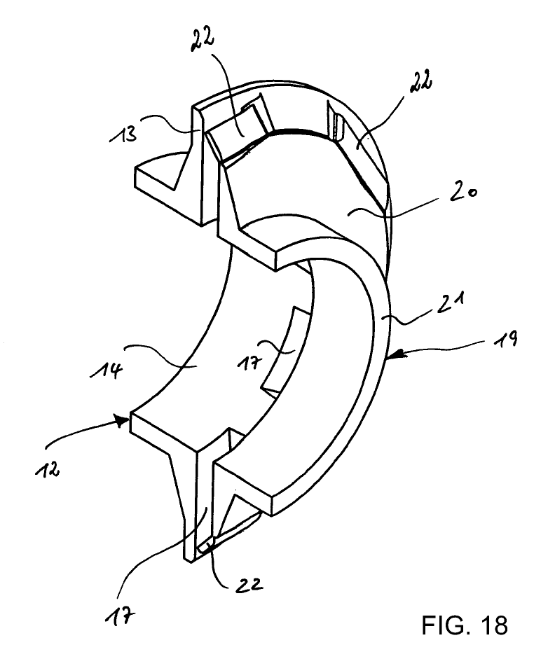

While FIGS. 14 to 16 show the distributor ring 12 and the associated support ring 19 in the filtration position with the protective lips 22 open, FIG. 17 shows the sectional illustration of FIG. 16 in the functional position during the ejection of the filter cake. Here, all six inlet ducts 17 are closed off by the respectively associated protective lips 22. Here, the lip contour is adapted to the rounding of the flange 13 of the distributor ring 12 such that the protective lip 22 nestles particularly closely against the flange 13 and thereby particularly effectively closes off the inlet duct 17. This can also be clearly seen from the sectional detail illustration of FIG. 18. On account of the shape of the protective lips 22, the membrane mat 26 (not illustrated in FIG. 17) bears against the entire contour without overexpansion when the protective lips 22 are closed.

The exemplary embodiments described on the basis of the figures of the drawing are in no way an exhaustive depiction of the invention. These are merely exemplary embodiments. Other embodiments are thus likewise conceivable. In particular, it is also conceivable for a single-piece component 35 to be provided for installation in the pulp inlet 9 of a filter panel according to FIG. 13 with a central pulp inlet 9. The invention is therefore also suitable for retrofitting in already-existing filter panel systems.

1. A filter panel pack, comprising:
at least one chamber filter panel, containing:
a pulp inlet formed therein and being substantially circular in cross section; and
a distributor ring disposed on said pulp inlet and having at least one inlet duct formed therein for pulp;
a membrane filter panel situated opposite said chamber filter panel, said membrane filter panel containing:
a pulp inlet formed therein and being substantially circular in cross section;
a support ring disposed on said pulp inlet of said membrane filter panel and situated opposite said distributor ring of said chamber filter panel;
a filter surface;
a membrane mat disposed on said filter surface; and
a filter cloth stretched over said membrane mat;
said chamber filter panel and said membrane filter panel enclosing a filter chamber, said membrane mat disposed on that side of said filter surface facing toward said chamber filter panel and with said filter cloth disposed on that side of said membrane mat facing toward said chamber filter panel; and
at least one protective lip pivotably mounted on said support ring and being spatially disposed substantially between said filter cloth and said distributor ring and which, when in its closed position, bears against said distributor ring and at least partially covers said inlet duct.

2. The filter panel pack according to claim 1, wherein said protective lip covers an end of said inlet duct.

3. The filter panel pack according to claim 1, wherein said distributor ring and said support ring are connected to one another to form a single-piece component.

4. The filter panel pack according to claim 3, wherein said inlet duct is one of a plurality of inlet ducts, said inlet ducts are disposed between said support ring and distributor ring.

5. The filter panel pack according to claim 3, wherein said component composed of said support ring and said distributor ring is mounted on said pulp inlet of said chamber filter panel.

6. The filter panel pack according to claim 1, wherein said support ring is supported on said distributor ring when said filter chamber is closed.

7. The filter panel pack according to claim 1, wherein said chamber filter panel has a further filter surface, a sealing edge bordering said further filter surface and said pulp inlet of said chamber filter panel is disposed in a region of said further filter surface.

8. The filter panel pack according to claim 7, wherein said pulp inlet of said chamber filter panel is disposed in a center of said further filter surface.

9. The filter panel pack according to claim 7, wherein said inlet duct if said chamber filter panel is one of a plurality of inlet ducts disposed in a stellate fashion.

10. The filter panel pack according to claim 9, wherein said inlet ducts are disposed at an angle of greater than or equal to 30° between said inlet ducts.

11. The filter panel pack according to claim 9, wherein said protective lip is one of a plurality of protective lips disposed in each case at an end of one of said inlet ducts.

12. The filter panel pack according to claim 1, wherein said chamber filter panel has a further filter surface, a sealing edge which borders said further filter surface and said pulp inlet of said chamber filter panel is disposed in said sealing edge.

13. The filter panel pack according to claim 1, wherein said chamber filter panel has a further filter surface, a sealing edge which borders said further filter surface and said pulp inlet of said chamber filter panel is disposed outside said further filter surface and outside said sealing edge.

14. The filter panel pack according to claim 12, wherein said inlet duct is one of a plurality of inlet ducts running parallel to one another.

15. The filter panel pack according to claim 12, wherein said inlet duct is one of a plurality of inlet ducts running at an angle of less than or equal to 30° with respect to one another.

16. The filter panel pack according to claim 1, wherein said support ring and said protective lip are composed of a same material.

17. The filter panel pack according to claim 1, wherein said protective lip is mounted on said support ring by means of a film hinge.

18. The filter panel pack according to claim 17, wherein said film hinge is composed of a pivotable hinge part, a carrier skirt and a flexurally rigid lip tab fixed to said carrier skirt.

19. The filter panel pack according to claim 18, wherein said flexurally rigid lip tab is attached to and can be removed from said carrier skirt and thereby exchanged.

20. The filter panel pack according to claim 1, wherein said protective lip releasably fixed to said support ring and thereby exchangeable.

21. The filter panel pack according to claim 13, wherein said inlet duct is one of a plurality of inlet ducts running parallel to one another.

22. The filter panel pack according to claim 13, wherein said inlet duct is one of a plurality of inlet ducts running at an angle of less than or equal to 30° with respect to one another.

23. A membrane filter panel for use in a filter panel pack, the membrane filter panel comprising:
a pulp inlet being substantially circular in cross section;
a support ring disposed in said pulp inlet;
a filter surface;
a membrane mat disposed on said filter surface;
a filter cloth being stretched over said membrane mat; and
at least one protective lip being pivotably mounted on said support ring.
